(19) United States
(12) Patent Application Publication
(10) Pub. No.: US 2024/0268940 A1
(43) Pub. Date: Aug. 15, 2024

(54) FLOSS DISPENSER

(71) Applicant: FLUSH HEALTH LTD., Glasgow (GB)

(72) Inventors: Brent VAN HOORN, Glasgow (GB); David LAW, Edinburgh (GB)

(73) Assignee: FLUSH HEALTH LTD., Glasgow (GB)

(21) Appl. No.: 18/569,058

(22) PCT Filed: Jun. 15, 2022
(86) PCT No.: PCT/EP2022/066370

§ 371 Date: Dec. 11, 2023

(30) Foreign Application Priority Data
Jun. 16, 2021 (GB) 2108582.4

(51) Int. Cl. A61C 15/04

(52) U.S. Cl. CPC A61C 15/043; A61C 15/046

(57) ABSTRACT

A dental floss dispenser (10) comprises a dispenser body (12) and a removable member (14) e.g. a lid. The dispenser body (12) and the removable member (14) are configured to be held, one in each of a user's hands whilst flossing. The removable member (14) is configured to receive at least a free end of floss, such that a length of useable floss extends and can be tensioned between the dispenser body (12) and the removable member (14). The dispenser body (12) includes a hollow container portion (16), a dispensing mechanism (20), and a dispensing aperture (92). The hollow container portion (16) is configured to contain dental floss for dispensing from the dispenser body (12). The dispensing mechanism (20), when actuated, is operable to feed floss along a pathway (95) defined within the dispenser body (12) to an exit through the dispensing aperture (92), which facilitates extraction of a free end and a continuous length of floss from the dispenser body (12).

### FIELD OF INVENTION

The present invention relates to improvements in dental floss dispensing, conserving dental floss and comfort for the user. In particular, the present invention relates to a reusable floss dispenser

### BACKGROUND TO THE INVENTION

Daily use of dental floss i.e. interdental cleaning is known to be an effective way of removing debris e.g. excess food particles from between teeth and at the gum-line, particularly in areas between the teeth where a toothbrush doesn't reach. Such debris contributes to plaque build-up. Therefore, regular flossing is a mechanism that is effective in helping prevent plaque build-up.

Typically, interdental cleaning, using a length of floss, is done by coiling or wrapping the ends of the length of floss around at least the index finger on both hands, supporting the length between the fingers by one or both thumbs (flossing between teeth of upper jaw) or by the middle fingers (flossing between teeth of lower jaw). Extending the floss over the pads of the thumbs or the middle fingers tensions the floss such that the application of the floss between the teeth is guided and sufficient pressure is applied.

Tensioning the floss on the pad/soft part of the fingertip and coiling the floss around the fingers can cause pain and discomfort and can even affect blood flow in the fingers if the floss is coiled tightly during use.

Typically, most of the floss wrapped around the fingers is never actually used as an interdental instrument and is merely used to provide sufficient length for coiling around the finger and applying sufficient tension in the region of floss that is used as an interdental instrument.

Dispensers have been developed to reduce physical contact with the floss and to control dispensing such that the need to coil the floss around a user's finger and to support floss on the fingers or thumbs to provide adequate tension and control is reduced.

### SUMMARY OF THE INVENTION

The present invention provides A dental floss dispenser comprising:
a dispenser body configured, in use, to be held in one of a user's hands; and
a removable member being configured, in use, to be held in the other of the user's hands and being configured to at least tension floss between the removable member and the dispenser body during flossing activity;
wherein the dispenser body includes a hollow container portion, a dispensing mechanism, and a dispensing aperture;
wherein the hollow container portion is configured to contain dental floss for dispensing from the dispenser body,
wherein actuation of the dispensing mechanism is operable to feed dental floss along a pathway defined within the dispenser body to an exit through the dispensing aperture, wherein the dispensing aperture facilitates extraction of a free end and a continuous length of floss from the dispenser body; and
wherein the removable member receives at least the free end of, such that, in use, a length of useable floss extends and can be tensioned between the dispenser body and the removable member.

Using the dispenser body and the removable member to tension floss eliminates the need to wrap floss around a user's finger because a desired length of useable floss can be extended and tensioned between the lid and the dispenser body.

It will be appreciated, by not wrapping floss directly around a user's finger, the risk of garrotting the finger is avoided.

The dispensing mechanism may include at least two mating components, wherein at least one component is an actuator, which is movable relative to another of the at least two mating components, wherein the dispensing mechanism is configurable between a non-dispensing configuration and a dispensing configuration.

The dispensing mechanism may be biased to the non-dispensing configuration and wherein activating the actuator changes the configuration of the dispensing mechanism from the non-dispensing configuration to the dispending configuration, wherein floss is released and extractable.

The actuator may be located at least partly within the dispenser body and includes at least an exposed actuating surface that is accessible from outside the dispenser body, wherein contact with the actuating surface activates the actuator and changes the configuration of the dispenser from the non-dispensing configuration to the dispensing configuration.

The actuating surface may be a push button member, which when depressed moves the actuator and releases floss such that the dispensing mechanism is the dispensing configuration and floss is extractable from the dispensing body

The dispensing mechanism may include at least one stationary member relative to which the actuator moves between the non-dispensing configuration and the dispensing configuration.

The at least one stationary member may be provided by a profiled inner surface of the dispenser body.

The actuator may also include a profiled surface, such that, in the non-dispensing configuration there is physical contact between at least one point on the profiled surface of the stationary member and at least one point on the profiled surface of the actuator such that floss can be clamped between the contact points of the profiled surfaces in the non-dispensing configuration. In the dispensing configuration the actuator moves relative to the stationary member to unclamp the floss such that a length of floss is extractable.

The actuator profile surface may include at least one physical clamping element, at least one passive clamping element and an arm member, which extends between the physical and passive clamping elements, where in the non-dispensing configuration the physical clamping element is in physical contact with at least on point on the profiled surface of the stationary member such that floss can be gripped therebetween.

The arm member may be configured to pivot about a pivot point, which is positioned adjacent to the passive clamping element, wherein in a non-dispensing configuration the physical clamping element is physically in contact with a portion of the profiled surface of the stationary member i.e. the dispenser body such that floss can be gripped therebetween and in transition from the non-dispensing configuration to the dispensing configuration the physical contact element moves out of contact with the profiled surface of the stationary member such that any floss held therebetween is released and is extractable.

The arrangement and configuration of the physical and passive clamping elements of the actuator and the profiled surface of the dispenser body is such that the dispensing mechanism performs as a clamping style belay device, which is activated by friction, wherein, in use, pulling on a free end of floss, creates a pulling force on the passive clamping member and rotation about the pivot point such that a clamping force is applied to the physical clamping element and floss is clamped between the physical clamping element and at least a point on the stationary member i.e. the profiled surface of the dispenser body. Pulling on a free end of the floss will take up any slack, and will cause the physical clamping member to grip/compress the floss between the mating surfaces, thereby preventing floss being pulled from the dispenser until the actuator is activated.

The pathway in which floss is received and guided, is visible on at least one of the stationary member and the actuator thereby providing a user with a target for placing floss correctly when loading or reloading the dispenser with floss. The pathway may be provided by a valley on the profiled surface of the stationary member i.e. the dispenser body.

The profiled surface of the stationary member, may include at least two contact members, wherein the physical clamping element and a corresponding contact member are configured to clamp floss between them in the non-dispensing configuration and wherein the passive clamping element and the other of the corresponding contact members are configured such that, in use, when a free end of floss is pulled an internal length of floss acts on the passive clamping element to cause rotation of the passive clamping element about the pivot such that the physical clamping element engages with the at least one contact point on stationary member and clamps floss therebetween.

In the non-dispensing configuration, pulling on the free end of floss causes the arm to rotate about the pivot point and causes the physical clamping element to move into physical contact with the stationary member at the location of one of the contact members.

The arm may be configured to define two lever arms, wherein a first lever arm extends between the pivot point and the passive clamping element and a second lever arm between the pivot point and the physical clamping element, wherein the first lever arm is shorter than the second lever arm.

The configuration of the lever arms is such that if floss is pulled in the non-dispensing configuration the clamping force applied between the physical clamping element and the corresponding increases by a factor of the ratio of the second lever arm to the first lever arm.

The profiled surface of the stationary member is configured to ensure floss is clamped in the non-dispensing configuration and to ensure floss is guided unhindered in the dispensing configuration, wherein the profiled inner surface is shaped to avoid contact with the physical clamping element and the passive clamping element in the dispensing configuration.

The profiled inner surface may include at least two ledges, wherein the physical clamping element and the passive clamping element are each configured to interact with one of the ledges in the non-dispensing configuration. Preferably, one or more of the mating surfaces include a smooth surface finish. A smooth surface finish ensures less damage to floss during clamping and during extraction. Alternatively, one or more of the mating surfaces may include toothed profiles such that the toothed profiles engage and clamp floss therebetween.

The actuator may include a resilient member, wherein operation in the dispensing configuration is by activating the actuator to overcome a biasing force provided by the resilient member, wherein the resilient member biases the dispenser to the non-dispensing configuration.

The removable member may include a receiving and storing mechanism. The receiving and storing mechanism may be externally mounted on the removable member, wherein a free end of floss and a length of floss is received and stored by the storage mechanism thereby permitting, in use, tensioning floss between the removable member and the dispenser body.

The receiving and storing mechanism may comprise a wheel component wherein floss is received and stored by winding floss around the wheel member. The wheel component may include a recessed circumference to permit winding of floss for storage and to facilitate tensioning of floss during use. The wheel component may rotate thereby facilitate winding of floss around the circumference of the wheel component. The wheel component may include a diametrical recess providing a floss guide into which a free end and a short length of floss can be received to prime the wheel component with floss, wherein the floss guide is operable to receive and hold an initial length of floss thereby aiding winding of floss around the wheel component either by hand or by rotating the wheel component.

At least a portion of the floss guide may include a constriction, which is configured to have higher friction and narrower geometry than the rest of the floss guide. The constriction facilitates temporarily grabbing and holding the floss while it is wrapped around the wheel component.

The constriction may include a section of rubber or elastomeric material such that the friction between the constriction and floss within the constriction is higher than friction in the rest of the floss guide.

Rotation of the wheel component may be by circumferential contact or external face contact. The wheel component may include a guide point on an external face, wherein the guide point facilitates rotation of the wheel component.

The removable member may be a lid.

The wheel component may be mounted on a head portion of the lid.

The head portion of the lid may include a feeder member, with which the floss guide aligns for ease of loading an initial length of floss to the lid.

It will be appreciated that after each flossing action a new portion of floss can be exposed by incrementally extracting floss from the dispenser and in response incrementally taking up used floss by winding on the wheel component. These actions can be done simultaneously where activating the actuator with one hand and operating the wheel component with the other hand feeds new floss and stores used floss in a single action.

Tensioning of floss for use can be resumed when the actuator is released, and the dispensing mechanism is in the non-dispense configuration.

The actuator may include a push button member, which when depressed moves the actuator out of contact with the profiled inner surface and releases floss such that the dispensing mechanism is the dispensing configuration and floss is extractable from the dispensing body.

The dispenser body may include a removable cap, wherein the cap is configured to fit the hollow container and to enclose floss within the hollow container.

The removable cap may include an aperture via which the actuator is accessible to the user.

The dispenser may include a guide member, operable to guide floss from the hollow container into a mouth of the pathway defined between the at least two mating members.

The guide member may include a guide slot extending in from one edge, wherein the guide slot is configured to receive and guide floss to the mouth of the pathway between the at least two mating members.

The guide member may be pivotally connected to the hollow container such that it can be moved to permit loading and replacing floss and, in use, to retain floss within the dispenser body.

The dispenser may further comprise a floss cutter. The floss cutter may be concealed.

The floss cutter may be located on the dispenser body. Alternatively, or in addition, the floss cutter may be located on the lid.

The floss cutter may be concealed behind an exposed member and be accessible via a guide having an entrance via the exposed member. The floss cutter may be embedded in the actuator and be accessible via a guide having an entrance at an edge of an exposed face of the actuator. The guide may be provided by a slot such that floss is admitted from a mouth of the slot into cutting contact with the floss cutter. The slot may extend upwards from a low edge of the exposed face of the actuator, wherein the mouth of the slot is provided at the low edge.

### BRIEF DESCRIPTION OF THE DRAWINGS

An embodiment of the present invention will now be described with reference to the accompanying drawings in which:

FIG. 1 illustrates a floss dispenser as a first example of the present invention, where the floss dispenser includes a dispenser body and a lid;

FIG. 2 illustrates an exploded view of the floss dispenser i.e. the floss dispenser body and lid of FIG. 1;

FIG. 3 illustrates an assembled view of the dispenser body;

FIG. 4 illustrates a head portion of the dispenser body, which includes an operating button and a cutting element, and illustrates how floss is cut by the cutting element;

FIG. 5 illustrates a perspective, sectioned view of the dispenser body including a to a guide member used to guide floss through a dispenser aperture from inside the floss dispenser body of FIG. 1;

FIG. 6 illustrates a plan view of the guide member;

FIG. 7 illustrates an example of a section view of a dispensing mechanism, which is included as part of the floss dispenser of FIG. 1;

FIG. 8 illustrates an alternative example of a dispensing mechanism, which could be used with the dispenser of FIG. 1;

FIG. 9 illustrates a front view of the lid shown in FIG. 1;

FIG. 10 illustrates a sectional side view of the head portion of the lid;

FIG. 11 illustrates a front view of the head portion of the lid;

FIG. 12 illustrates a top plan view of the lid;

FIG. 13 illustrates a sectional side view of the head portion of the lid showing the path for floss; and

FIG. 14 illustrates a front view of the head portion of the lid and shows how floss is taken-up and stored during use of the floss dispenser.

### DESCRIPTION

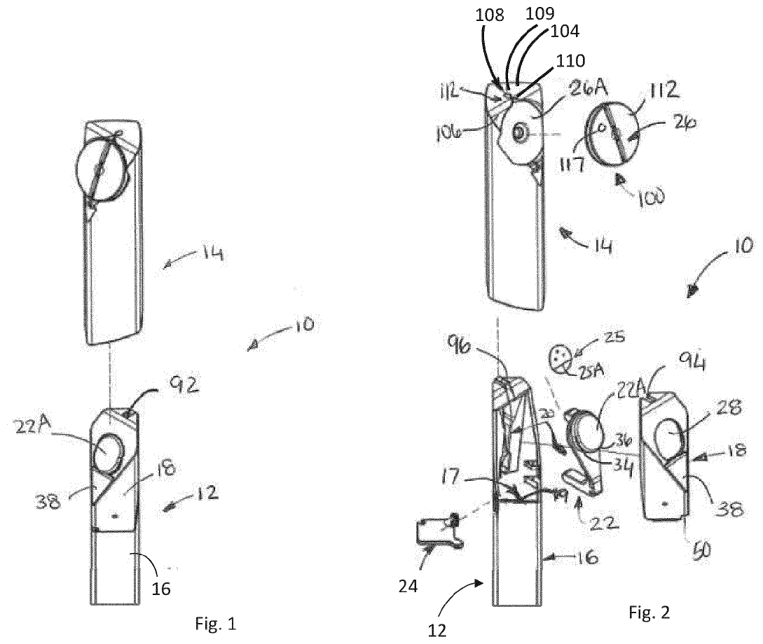

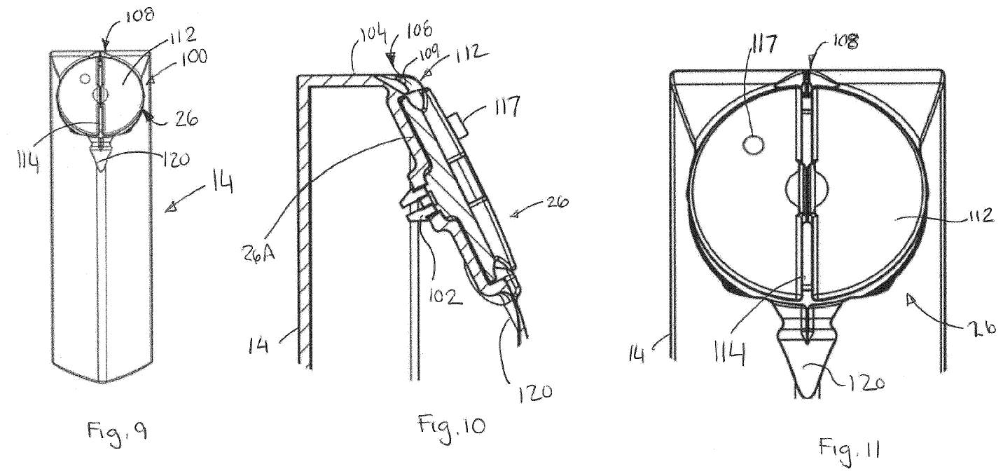

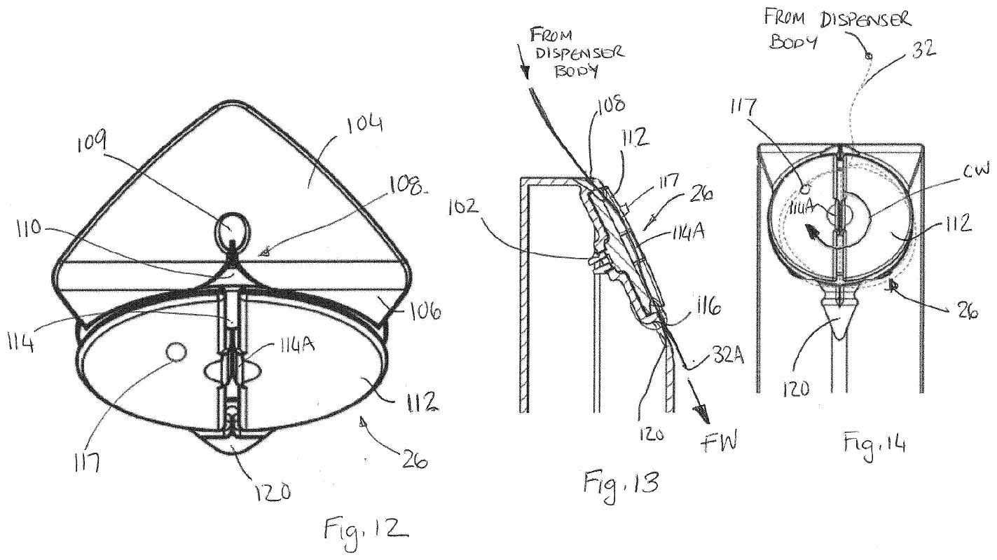

FIGS. 1 to 14 illustrate features of a floss dispenser 10 as an example of the present invention. Referring to FIG. 1 and FIG. 2, the floss dispenser 10 includes a dispenser body 12 and a removable lid 14. The shape and configuration of the illustrated dispenser 10 is similar to a cosmetic lipstick, which makes it compact and suitable to carry hygienically in a pocket or bag for easy retrieval and easy use.

As shown in an exploded/disassembled configuration in FIG. 2, the dispenser body 12 includes a container portion 16, a removable cap/closure member 18, a dispensing mechanism 20, an actuating member 22, a guide member 24, and a cutting element 25.

The container portion 16 includes a housing 17, which is configured to contain dental floss (not illustrated).

In the illustrated example, the cap 18 is configured to be removed completely from the container portion 16 to provide access to inside the container portion 16 and the housing 17 to permit initial loading, reloading and feeding of floss from the housing to the exit 92 of the dispenser body 12. However, it will be appreciated the cap 18 may be hinged or connected to the container portion 16 in a manner that permits access to inside the container portion 16 whilst also preventing misplacement of the cap 18. For example, the cap 18 may be hinged to the upper edge 19 of the housing 17, such that the cap 18 remains attached at all time and misplacement is avoided.

The lid 14 is a hollow container, which is shaped to receive the dispenser body 12.

The lid 14 includes a wheel member 26, which is configured to hold and store floss as it is being used. Operation of the wheel member 26 is described further below with reference to FIGS. 9 to 14.

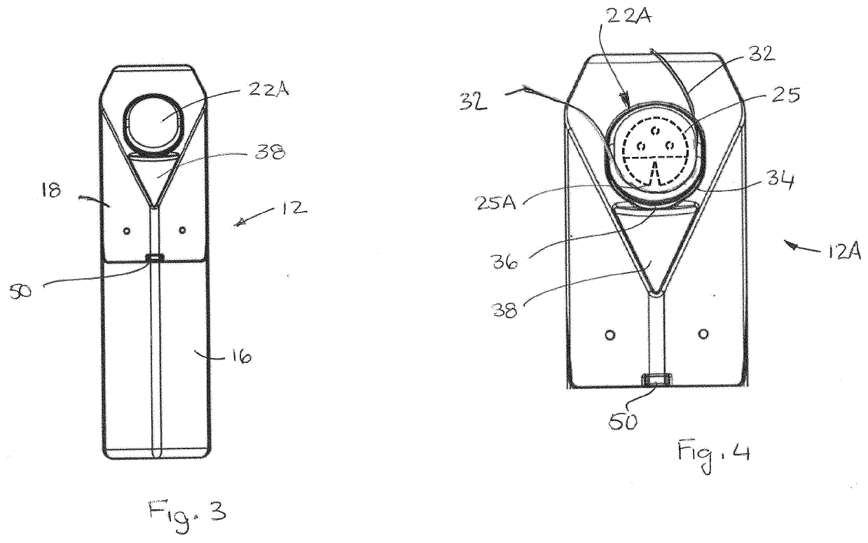

FIG. 3 illustrates an assembled dispenser body 12, which includes the cap/closure member 18 engaged with the container portion 16.

FIG. 4 illustrates the upper capped portion 12A of the dispenser body 12 and illustrates how floss 32 can be cut using the cutting element 25.

Referring to FIG. 1 to FIG. 4, the cap 18 includes a window 28 via which a push button 22A part of the actuating member 22 is exposed i.e. is accessible from outside of the dispenser body 12. The function of the push button 22A and the actuating member 22 is described further below with reference to FIG. 7.

In the illustrated example, the cutting element 25 is concealed behind a front surface of the push button 22A and within the body of the actuating member 22. A cutting blade 25A, as part of the cutting element 25 is accessible via a slot/guide 34 provided behind the exposed push button 22A.

The blade 25A, is configured to cut dispensed floss 32 when the floss 32 is pulled into contact with the blade 25A as illustrated in FIG. 4.

The slot/guide 34 extends upwards from the lowest edge 36 of the push button 22A such that the cutting blade 25A is accessible but is also concealed behind the push button 22A.

The slot/guide 34 is configured to guide floss 32 into contact with the blade 25A for cutting a length of floss 32 or used floss 32. The slot/guide 34 creates a safe recessed cutting surface and prevents snagging when the dispenser 10 is carried in a pocket, bag etc.

To cut a length of floss 32, the floss 32 is guided via the slot 34 into the mouth of the cutting element 25 and into contact with the blade 25A. An indentation 38 on the front face of the cap 18 and positioned below the push button 22A provides an unhindered pathway for the floss 32 to enter the mouth of the slot 34 and to advance into the slot 34. The slot 34 and the indentation 38 collectively provide a floss cutter guide.

It will be appreciated, an alternative floss cutter may be provided and it mat be concealed or not concealed. For example, a floss cutter may be provided on the dispenser body 12 or lid 14.

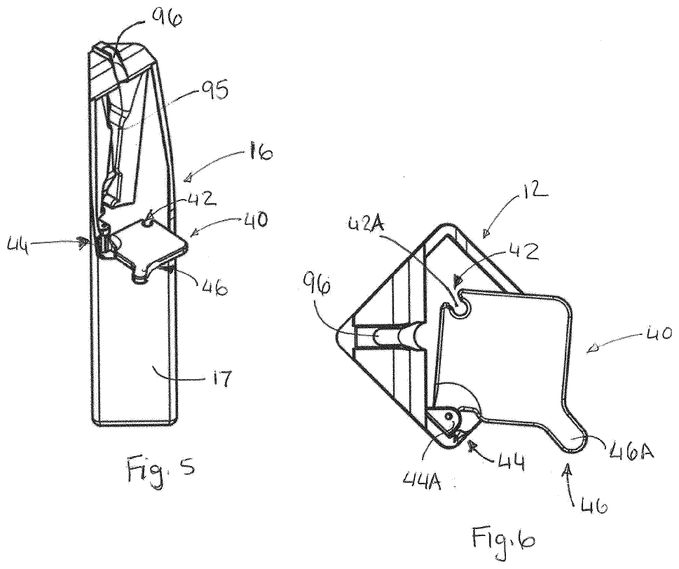

Referring to FIGS. 5 and 6 the container portion 16 is illustrated to illustrate the configuration and function of the internal guide member 40 relative to the container portion 16 and the housing 17. In the illustrated example, the guide member 40 is a plate that is shaped to cover the housing 17 such that the floss material (not shown), is contained in the housing 17. The plate includes a notched edge 42, a pivotal edge 44 and a locating edge 46.

The notched edge 42 includes a notch 42A, which is configured to receive and guide floss 32 into the pathway of the dispensing mechanism 20 i.e. valley 95 and to the exit channel 96. The exit channel 96 forms one half of the dispensing aperture 92 i.e. the exit from the dispenser body 12 (see FIG. 1).

The pivotal edge 44 includes a hinge 44A, which facilitates displacing the guide member 40 to gain access to the housing 17 and the floss contained therein and to locate the guide member 40 across the housing 17 to protect and retain the floss therein.

Pivoting the guide member 40 about the hinge 44A and relative to the container portion 16 and housing 17 permits installation of floss e.g. a reel/bobbin of floss in the housing 17 for a first use and for replacement of depleted floss thereby allowing the dispenser 10/dispenser body 12 to be re-useable.

By hinging the guide member 40 to the container portion 16, the guide member 40 prevents the cap 18 being replaced until the guide member 40 is correctly oriented relative to the container portion 16 and housing 17. When correctly positioned, the guide member 40 retains the floss (not illustrated) in the housing 17 and guides the floss 32 to the dispensing mechanism 20.

The locating edge 46 includes a protruding tab 48, which provides a tactile feature that assists the user pivoting the guide member 40 about the hinge 44A.

The protruding tab 48 also acts as a marker to indicate that the guide member 40 is in the appropriate position to permit installation/replacement of the cap 18. With reference to FIGS. 2, 3 and 4, the cap 18 includes a recess 50, which is shaped to correspond with the tab 48. Therefore, in the illustrated example, the tab 48 and the recess 50 align when the guide member 40 is in the correct orientation and the cap 18 can be fully received on the container portion 16.

The recess 50 also facilitates removal of the cap 18 from the dispenser body 12.

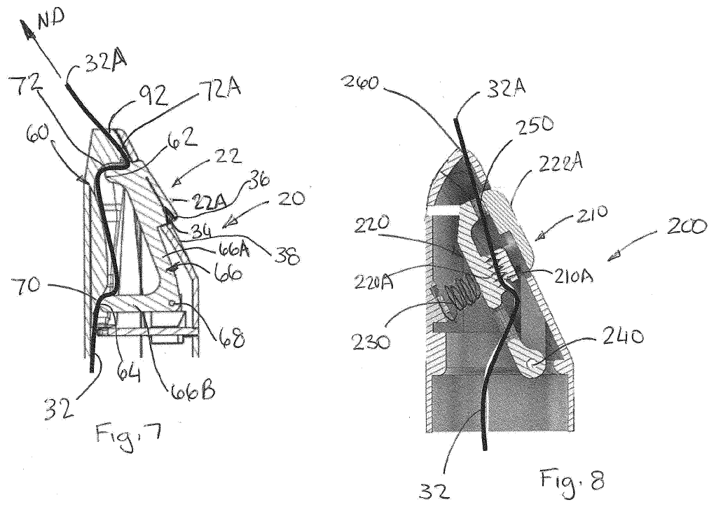

FIG. 7 and FIG. 8 each illustrate a cross-sectional view of a head portion of the dispensing body 12. Each figure illustrates an example of a dispensing mechanism 20, 200 that can be used with the dispenser 10 to control extraction/dispensing of floss 32 from within the container portion 16.

FIG. 7 represents the dispensing mechanism 20 included with the dispenser 10, as illustrated in FIG. 2. FIG. 8 represents an alternative dispensing mechanism 200, which could be implemented with the dispenser 10.

Referring to FIG. 7, the illustrated dispensing mechanism 20 is an example of a belay mechanism, which includes two mating members 22, 60 i.e. a moving member 22 and a stationary member 60 that interact in a dispensing configuration to dispense floss 32 and in a non-dispensing configuration to lock floss 32 between at least one contact point/surface 64 on the moving member 22 and at least one contact point/surface 70 on the stationary member 60 to prevent floss being extracted.

The stationary member 60 is provided by a profiled inner surface of an upper part of the container portion 16 i.e. as part of the dispenser body 12. In the illustrated example, the moving member i.e. the actuating member 22 includes a protruding element 64 (a physical clamping element) which provides a contact point/surface 64, which is configured to press against a contact surface 70 on the stationary member 60 to lock floss.

The actuating member 22 also includes a profiled surface, which includes two protruding elements 62, 64 and an arm member 66, which extends between the first (upper) element 62 and the second (lower) element 64. The arm member 66 is configured to pivot about a pivot point 68, which is located adjacent to the second element 64.

In the illustrated example, the stationary member 60, includes a clamping surface 70 configured to engage with and guide the second (lower) element 64 and to clamp floss therebetween in the non-dispensing configuration.

The upper portion of the stationary member 60 is configured to guide floss along a circuitous path defined by the surfaces of a concave portion 72 and a convex portion 72A.

In the dispensing configuration, the floss 32 engages with these surfaces 72, 72A and is guided through the valley 95 to the exit 92.

In the non-dispensing configuration, if a user pulls on the free end 32A of the floss 32, in the direction of arrow ND, the abrupt change in direction from the concave portion 72 to the convex portion 72A pulls the floss 32 into contact with the contact element 62 of the actuating member 22. When the actuator 22 is parked in the non-dispensing configuration (see FIG. 7), pulling on the floss 32 causes the actuator 22 to move i.e. to rotate about the pivot point 68 in a clockwise direction and causes element 64 to press the floss 32 against the clamping surface 70 such that the floss 32 is clamped and cannot be extracted from the dispenser 10.

The floss 32 remains clamped/locked until the actuator 22 is activated i.e. the button 22A is depressed to cause anticlockwise rotation of the arm 66 about the pivot point 68 such that the element 64 moves away from the clamping surface 70 and releases the floss 32 clamped therebetween.

An advantage of the dispensing mechanism 20, as illustrated in FIG. 7, is that increasing pulling force on the floss 32 increases the clamping force and ensures a clamping force is applied to the floss 32 being held between the clamping surface 70 and physical clamping element 64.

The configuration of the lever arm 66 affects the clamping force between the clamping surface 70 and the clamping element 64 and affects the effectiveness of clamping floss therebetween. This is due to the length of the lever arm 66A defined between the pivot point 68 and the upper element 62 being longer than the lever arm 66B defined between the pivot point 68 and the lower element 64 (and the clamping surface 70).

A further advantage of the configuration of the dispensing mechanism 20, as illustrated in FIG. 7, is that the mechanism does not require additional components e.g. springs to overcome the clamping force or to lock/clamp the floss. As noted above, applying a force to the floss 32 being pulled through the dispensing mechanism 20 is all that is required to ensure the floss 32 is clamped/locked against extraction and depressing the actuator button 22A i.e. activating the actuator 22 is all that is required to release the clamping load, which permits floss 32 to be extracted.

It will be appreciated the clamping surfaces 70, 64 are smooth. This is advantageous also because there are no edges or surface finishes that can affect the integrity of the floss whilst it is being used. For example, a surface including a textured finish e.g. teeth to aid gripping may damage floss clamped therebetween or as floss is pulled over the gripping surfaces.

It will be appreciated, to effectively clamp a material between mating toothed/textured surfaces, the toothed/textured surfaces often require tight tolerances. However, the dispensing mechanism as illustrated in FIG. 7 is much more effective with greatly reduced tolerance requirements.

Releasing floss 32 such that it can be extracted/dispensed from the dispenser body 12 is facilitated by the actuating member 22 and the push button 22A. Upon depressing the button 22A i.e. inwardly relative to the dispenser body 12 the elements 62, 64 are displaced in a downward arc, which disengages the element 64 from mating contact with the clamping surface 70 and consequently releases/frees the floss 32. Whilst the button 22A is depressed a length of floss 32 can be pulled from the dispenser body 12 via the dispensing aperture 92 with ease. Upon releasing pressure on the button 22A the actuating member 22 returns to the status shown in FIG. 7 such that pulling on the free end 32A of the floss 32 encourages the illustrated non-dispensing configuration (described above with reference to FIG. 7).

The floss 32 exits the dispenser body 12 via the dispensing aperture 92 provided at the top of the dispenser body 12. In the illustrated example, the dispensing aperture 92 is created by the alignment of two channels 94, 96, where one channel 94 is provided on the head portion of the cap 18 and the second channel 96 is provided on the head portion of the container 16 (see FIG. 2). This arrangement simplifies loading and reloading floss because the pathway i.e. valley 95 is visible to the user when the cap 18 is removed.

Referring to FIG. 8, an alternative dispensing mechanism 200 to that illustrated in FIG. 7 is shown. In contrast to the dispensing mechanism 20 (FIG. 7) this dispensing mechanism 200 includes spring bias and toothed mating surfaces. Like the dispensing mechanism 20, this dispensing mechanism 200 is biased to a non-dispensing configuration and requires activation to change configuration to a dispensing configuration as described further below with reference to FIG. 8

The dispensing mechanism 200 includes two mating members 210, 220, which each include serrated/toothed surfaces 210A, 220A. The surfaces 210A, 220A are each configured to grip/clamp floss 32 between them in the locked configuration i.e. non-dispensing configuration as illustrated in FIG. 8. The mating members 210, 220 are biased to the non-dispensing configuration under the action of a spring 230.

Releasing floss 32 such that it can be extracted/dispensed from the dispenser body 12 is facilitated by pressing a push-button actuating member 222A, which overcomes the spring force and displaces the first mating member 210 by rotation about a pivot point 240.

When the button 222A is depressed inwardly it acts on an upper member 250 of the first mating member 210 and displaces the first mating member 210 i.e. rotates the first mating member 210 about pivot point 240 to allow floss 32 to be pulled through the dispensing aperture 260.

Whilst the button 222A is depressed a length of floss 32 can be pulled from the dispenser body with ease. Upon releasing pressure on the button 222A the mating members 210, 220 return to the status shown in FIG. 8 and the floss 32 is once again clamped.

During flossing i.e. using the dispenser 10 as illustrated in FIG. 1, the dispenser body 12 is expected to be held in one hand and the dispenser lid 14 i.e. a removable member is expected to be held in the user's other hand.

Before use, the lid 14 is intended to be primed with a free end 32A and a short portion of floss 32 dispensed from the dispenser body 12 such that a length of floss extends between the lid 14 and the dispenser body 12, wherein the dispenser body 12 and the lid 14 facilitate tensioning floss during use and such that used floss can be taken-up and stored on the lid 14 as clean floss is dispensed from the dispenser body 12.

The lid 14 is illustrated and described further here with reference to FIG. 9 to FIG. 14.

As noted above the lid 14 is removable from the dispenser body 12. The lid 14 includes a hollow body which is shaped and configured to receive the dispenser body 12. The configuration of the assembled dispenser body 12 and lid 14 is similar to a cosmetic lipstick.

The lid 14 includes a wheel member 26, which is operable, in use, to receive floss, to guide floss, to tension floss, and to store used floss.

In the illustrated example, the wheel member 26 is located within a complementary recess 26A on an upper-front surface of the lid 14. The wheel member 26 includes a snap-fit hub 102 which securely connects the wheel member 26 to the lid 14 whilst also permitting rotation of the wheel member 26 relative to the lid 14.

The top 104 and upper front edge 106 of the lid 14 includes a feeder guide 108, formed by a hole 109 and elongated indent 110. The feeder guide 108 facilitates initial priming/feeding floss onto the wheel member 26.

The external face 112 of the wheel member 26 includes a diametrical recess 114, hereafter referenced as the wheel guide 114, which when aligned with the feeder guide 108 facilitates priming the wheel member 26 with floss extending from the dispenser body 12 (not shown in FIGS. 9 to 14).

As shown in FIG. 13, a free end 32A of floss 32 is fed downwards through the feeder guide 108 and into the wheel guide 114 such that the free end 32A and a short length of floss 32 exits the lowest point 116 of the wheel guide 114 in the direction of arrow FW.

After this portion of floss 32 is loaded in the wheel guide 114 the wheel member 26 can be rotated such that floss 32 is wound around the outer circumference of the wheel member 26.

In the illustrated example (see FIG. 14), the wheel member 26 is rotated clockwise CW to create a number of turns of floss 32 about the wheel member 26, thereby securing floss 32 to the wheel member 26 such that, in use, the lid 14 can be used to tension the floss 32. This arrangement avoids the need to wrap floss 32 around the user's fingers, avoids garrotting fingers and/or thumbs with floss and may also reduce the amount of floss being used.

It will be appreciated the wheel member 26 could be rotated in either a clockwise or anticlockwise direction when loading with floss initially.

The wheel member 26 may include a one direction ratchet (not illustrated) such that rotation for loading/priming the wheel member 26 is a fixed rotation direction. This would allow the floss to be wound up but prevent backwinding when the floss is used. A button or similar would be included to disengage the ratchet to allow the floss to be unwound.

In the illustrated example, the wheel member 26 is configured such that it can be rotated by contact by the user's thumb pad or finger pad with the outer circumference of the wheel member 26 or alternatively contact by the user's thumb pad or finger pad with the front face 112 of the wheel member 26. This configuration means that the floss can be wound about the wheel member 26 with ease whilst a person is flossing.

The wheel member 26 may include a guide point 117, which in the illustrated example is located on the front face 112. The guide point 117 protrudes from the front face 112 and facilitates contact with the user's finger or thumb to rotate the wheel member 26 whilst loading or unloading floss.

The wheel member 26 and the wheel guide 114 may include at least a section of rubber or elastomeric material, which facilitates a resistance to sliding and thereby aids loading floss in the wheel guide 114 and spooling the floss on the wheel member 26 initially and during flossing activity.

In the illustrated example, the centre section 114A of the wheel guide 114 includes a constriction 114A which is configured to have higher friction and narrower geometry than the rest of the wheel guide 114. The constriction 114A facilitates temporarily grabbing and holding the floss 32 while it is wrapped around the wheel member 26. The constriction 114A may include the section of rubber or elastomeric material as noted above such that the friction between the constriction 114A and floss 32 within the constriction 114A is higher than friction in the rest of the wheel guide 114.

In the illustrated example, the lid 14 includes an indent 120 beneath the wheel member 26. The indent 120 facilitates thumb or finger placement to keep floss in place whilst loading the wheel member 26 with floss initially.

When the flossing activity is complete the used floss can be cut from the dispenser body 12 as described above with reference to FIG. 4 and surplus floss can be wound around the wheel member 26 to contain used floss until safe disposal.

In the illustrated example, removal of the used floss from the wheel member 26 can be done by backwinding the wheel member 26 i.e. rotating the wheel member 26 in the opposite direction to the loading direction e.g. anticlockwise for the given example.

Removal of used floss from the wheel member 26 might incorporate cutting the floss, for example the wheel member 26 may include a cutter (not illustrated) wherein depressing one or both halves of the face of the wheel member 26 cuts the floss wrapped around the wheel member 26 such that the floss is removed without the need to unwind it.

Another example of removing used floss might include the face of the wheel member 26 or at least a part of it being configured to flip up/outwards such that the floss wrapped behind the wheel member 26 can fall off. A yet further example of how to remove used floss might include the wheel member 26 being removable to remove the floss and then the wheel member 26 can be restored for another flossing activity.

Whilst specific embodiments of the present invention have been described above, it will be appreciated that departures from the described embodiments may still fall within the scope of the claims.

1. A dental floss dispenser comprising:
a dispenser body configured, in use, to be held in one of a user's hands; and
a removable member being configured, in use, to be held in the other of the user's hands and being configured to at least tension floss between the removable member and the dispenser body during flossing activity;
wherein the dispenser body includes a hollow container portion, a dispensing mechanism, and a dispensing aperture;
wherein the hollow container portion is configured to contain dental floss for dispensing from the dispenser body,
wherein actuation of the dispensing mechanism is operable to feed floss along a pathway defined within the dispenser body to an exit through the dispensing aperture, wherein the dispensing aperture facilitates extraction of a free end and a continuous length of floss from the dispenser body; and
wherein the removable member receives at least the free end of floss, such that, in use, a length of useable floss extends and can be tensioned between the dispenser body and the removable member.

2. The dental floss dispenser as claimed in claim 1, wherein the dispensing mechanism includes at least two mating components, wherein at least one component is an actuator, which is movable relative to another of the at least two mating components, wherein the dispensing mechanism is configurable between a non-dispensing configuration and a dispensing configuration.

3.-5. (canceled)

6. The dental floss dispenser as claimed in claim 1, wherein the dispensing mechanism includes at least one stationary member relative to which the actuator moves between the non-dispensing configuration and the dispensing configuration.

7. The dental floss dispenser as claimed in claim 6, wherein the at least one stationary member is provided by a profiled inner surface of the dispenser body.

8. The dental floss dispenser as claimed in claim 7, wherein the actuator includes a profiled surface, such that, in the non-dispensing configuration there is physical contact between at least one point on the profiled surface of the stationary member and at least one point on the profiled surface of the actuator such that floss can be clamped between the contact points of the profiled surfaces in the non-dispensing configuration.

9. The dental floss dispenser as claimed in claim 8, wherein the profiled surface of the actuator includes at least one physical clamping element, at least one passive clamping element and an arm member, which extends between the physical and passive clamping elements, where in the non-dispensing configuration the physical clamping element is in physical contact with at least on point on the profiled surface of the stationary member such that floss can be gripped therebetween.

10.-12. (canceled)

13. The dental floss dispenser as claimed in claim 6, wherein the pathway in which floss is received and guided is visible on at least one of the stationary member and the actuator.

14. The dental floss dispenser as claimed in claim 13, wherein the pathway is provided by a valley on the profiled surface of the stationary member.

15. The dental floss dispenser as claimed in claim 14, wherein the profiled surface of the stationary member includes at least two contact members, wherein the physical clamping element and a corresponding contact member are configured to clamp floss between them in the non-dispensing configuration and wherein the passive clamping element and the other of the corresponding contact members are configured such that, in use, when a free end of floss is pulled an internal length of floss acts on the passive clamping element to cause rotation of the actuator about the pivot such that the physical clamping element engages with the at least one contact point on the stationary member and clamps floss therebetween.

16. The dental floss dispenser as claimed in claim 9, wherein the arm member includes two lever arms, wherein a first lever arm extends between the pivot point and the passive clamping element and a second lever arm extends between the pivot point and the physical clamping element, wherein the first lever arm is shorter than the second lever arm.

17. The dental floss dispenser as claimed in claim 16, wherein the configuration of the lever arms is such that if floss is pulled in the non-dispensing configuration a clamping force applied between the physical clamping element and the corresponding stationary contact element increases by a factor of the ratio of the second lever arm to the first lever arm.

18.-35. (canceled)

36. The dental floss dispenser as claimed in claim 1, wherein the dispenser body includes a removable cap, wherein the cap is configured to fit the hollow container and to enclose floss within the hollow container.

37. The dental floss dispenser as claimed in claim 36, wherein the dispensing mechanism includes at least two mating components, wherein at least one mating component is an actuator which is movable relative to another of the at least two mating components, wherein the removable cap includes an aperture via which the actuator is accessible to the user.

38.-39. (canceled)

40. The dental floss dispenser as claimed in claim 37, wherein the guide member is pivotally connected to the hollow container such that it can be moved to permit loading and replacing floss and, in use, to retain floss within the dispenser body.

41. The dental floss dispenser as claimed in claim 1, further comprising a floss cutter.

42. (canceled)

43. The dental floss dispenser as claimed in claim 41, wherein the removable member is a lid, the floss cutter being located on the lid.

44. The dental floss dispenser as claimed in claim 41, wherein the floss cutter is concealed behind an exposed member and is accessible via a guide having an entrance via the exposed member.

45. The dental floss dispenser as claimed in claim 44, wherein the floss cutter is embedded in the actuator and is accessible via a guide having an entrance at an edge of an exposed face of the actuator.

46. The dental floss dispenser as claimed in claim 45, wherein the guide is a slot such that floss is admitted from a mouth of the slot into cutting contact with the floss cutter.

47. The dental floss dispenser as claimed in claim 46, wherein the slot extends upwards from a low edge of the exposed face of the actuator.
